(19) United States
(12) Patent Application Publication
(10) Pub. No.: US 2019/0050012 A1
(43) Pub. Date: Feb. 14, 2019

(54) VOLTAGE REGULATOR WITH IMPROVED SLEW RATE

(71) Applicant: MACRONIX INTERNATIONAL CO., LTD., HSINCHU (TW)

(72) Inventors: Shang-Chi YANG, Changhua (TW); Su-Chueh LO, HSINCHU (TW)

(73) Assignee: MACRONIX INTERNATIONAL CO., LTD., HSINCHU (TW)

(21) Appl. No.: 15/673,644

(22) Filed: Aug. 10, 2017

(51) Int. Cl. G05F 1/575

(52) U.S. Cl. CPC G05F 1/575

(57) ABSTRACT

A voltage regulator supplies a regulated voltage on an output node. The voltage regulator includes a two stage amplifier which controls an output leg including the output node, and a feedback circuit between the output node and an input of the amplifier. The first stage is connected to a first power supply circuit configured to be connected to a first power supply, such as a charge pump. The second stage is connected to a second power supply circuit configured to connect to a second power supply, such as an external power supply. The first power supply and second power supply are different. The second stage is turned off during a transition in current loading, before the first stage, so that final control of the regulated voltage can be achieved using the first stage, and the slew rate is boosted using the second stage.

### TECHNICAL FIELD

The present invention relates to voltage regulators, including voltage regulators used in integrated circuits having rapidly changing loads.

### DESCRIPTION OF RELATED ART

Voltage regulators are utilized in integrated circuit design to provide a supply voltage to circuitry internal to the integrated circuit that can be more stable than an external power supply.

In integrated circuits having rapidly changing loads, the transient response and slew rate of the voltage regulator can be a limiting property. If the current load of the target circuit changes rapidly, such as on the order of the transient response of the voltage regulator, then the slew rate of the voltage regulator can be a limiting factor in circuit performance.

For example, a voltage regulator, in a class of regulators known as low dropout LDO voltage regulators, comprises an output leg having a power MOSFET connected between an external power supply and the output node of the regulator. The gate of the power MOSFET is driven by an amplifier with a feedback loop to maintain constant voltage on the output node. The power MOSFET can be very large, and have a large gate capacitance.

LDO regulators can use an operational amplifier to drive the gate voltage of the power transistor. The feedback loop is connected between the output voltage on the power transistor and an input of the operational amplifier. A steady reference voltage such as a bandgap reference is applied to a second input of the operational amplifier. The high gain of the operational amplifier operates with feedback to maintain the output voltage steady. However, when fast transitions occur in a target circuit being driven by the voltage regulator, the output voltage can fluctuate as response time can be limited by the power transistor in the feedback loop.

In some embodiments, the output voltage of the regulator can be close to or even larger than the external supply voltage. In these embodiments, a charge pump can be used to provide a supply voltage to at least an output stage of the operational amplifier, while an external power supply is connected to the output leg of the voltage regulator. The charge pump must be powerful enough to provide a large supply current needed to meet any slew rate specifications for the circuit. In order to produce a large enough supply current in some circuits, the charge pump must be relatively large, consuming circuit area on the integrated circuit. Also, power consumption of the integrated circuit can suffer because of the need to drive large charge pumps.

It is desirable to provide a voltage regulator suitable for use in integrated circuits, with a stable output voltage during fast transitions in current loading in a target circuit that can conserve area and power on an integrated circuit.

### SUMMARY

A circuit and a method are described for supplying a regulated voltage to a target circuit which can conserve area and power.

A voltage regulator is described that supplies a regulated voltage on an output node connected to a target circuit. The voltage regulator includes a two-stage amplifier which controls an output leg of the voltage regulator including the output node, and a feedback circuit between the output node and input of the amplifier. The first stage is connected to a first power supply circuit configured to be connected to a first power supply, such as a charge pump. The second stage is connected to a second power supply circuit configured to connect to a second power supply, such as an external power supply. The first power supply circuit and second power supply circuit are different, allowing for connection to different power supplies. The second stage is turned off during a transition in current loading before the first stage so that final control of the regulated voltage can be achieved using the first stage, and the slew rate can be made faster using the second stage.

One example of such a circuit described herein includes a first operational amplifier and a second operational amplifier. A gate of a transistor on an output leg of the circuit is connected to the output of the first operational amplifier and to the output of the second operational amplifier. A first terminal of the transistor, such as a drain, receives a power supply voltage, and a second terminal of the transistor, such as a source, is connected to an output node of the regulator circuit. A feedback circuit is connected between the output node and feedback inputs of the first and second operational amplifiers. A first power supply circuit is connected to the first operational amplifier, and configured to be connected to a first power supply. A second power supply circuit is connected to the second operational amplifier, and configured to be connected to a second power supply. The circuit is configured using one or both of bias voltages and circuit structures so that the second operational amplifier turns off before the first operational amplifier during transitions in current loading in the target circuit.

A method for supplying a regulated voltage to a target circuit characterized by fast changes in current loading is also described. In one example described herein, the method includes applying the regulated voltage on an output node coupled to the target circuit, using a first amplifier stage and a second amplifier stage. The method includes supplying power to the first amplifier stage using a first power supply, such as a charge pump, and supplying power to the second amplifier stage using a second power supply. The second power supply can have a higher driving power than the first power supply. During a transition in current loading on the output node, the method includes turning off the second amplifier stage before the first amplifier stage. In this manner, the combination of the first amplifier stage and the second amplifier stage can drive the output node of the voltage regulator during a first part of transition in current loading on the output node for a faster slew rate, and the first amplifier stage can drive the output node based on the first power supply for finer control during second part of the transition.

Other aspects and advantages of the present technology can be seen on review of the drawings, the detailed description and the claims, which follow.

### BRIEF DESCRIPTION OF THE DRAWINGS

FIG. 1 is a simplified block diagram of a device including a fast slew rate voltage regulator as described herein.

FIG. 2 is a circuit diagram of a device including a fast slew rate LDO voltage regulator and slew rate boosting circuit as described herein.

### DETAILED DESCRIPTION

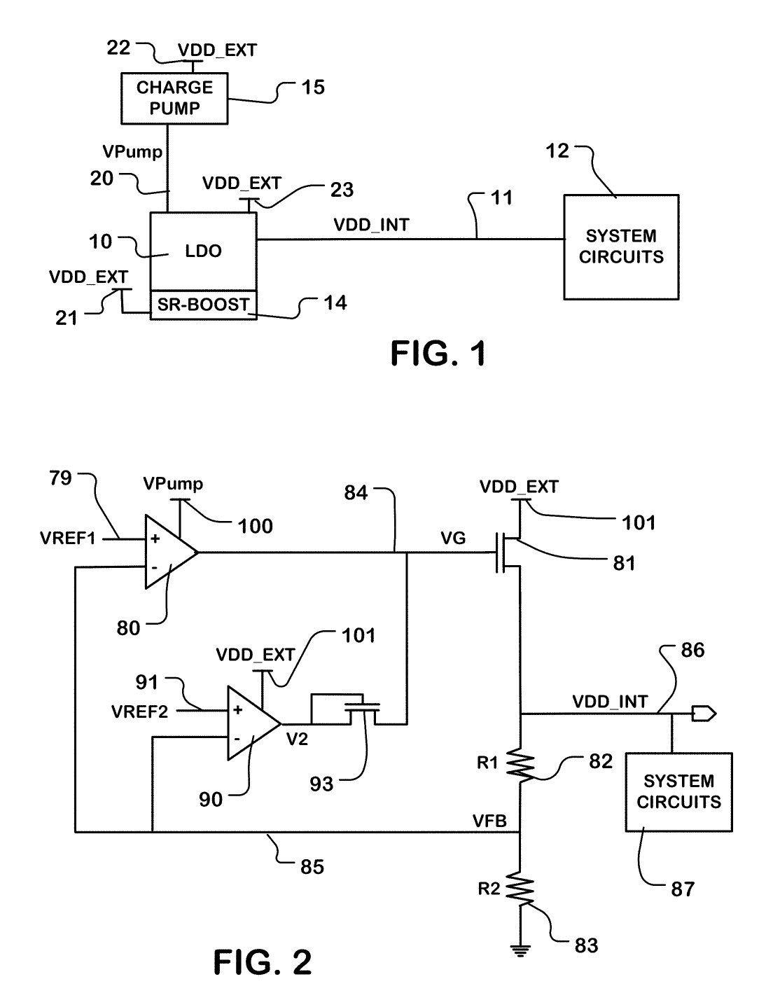

A detailed description of embodiments of the present invention is provided with reference to the FIGS. 1-2.

FIG. 1 illustrates a voltage regulator connected to a target system circuit 12. The voltage regulator in this example comprises an LDO circuit 10 that includes a slew rate boost circuit 14. The voltage regulator including the LDO circuit 10 supplies a regulated voltage VDD_INT as an internal supply voltage on an output node 11 to a target circuit, such as all or part of system circuits 12 on the same integrated circuit as the voltage regulator. In this example, the LDO circuit 10 includes a first stage amplifier, and the slew rate boost circuit 14 includes a second stage amplifier, for the voltage regulator. The LDO circuit 10 is coupled by a first power supply circuit 20 to a first power supply such as charge pump 15, which is in turn powered by an external power supply which generates a voltage VDD_EXT, and which generates a voltage Vpump. The slew rate boost circuit 14 is coupled by a second power supply circuit 21 to a second power supply, which can be the same external power supply that generates the voltage VDD_EXT. The voltage levels provided by the first and second power supplies to the first and second power supply circuits can be different. Also, the power levels achievable by the first and second power supplies can be different.

The voltage regular includes an output leg (not shown) which powers the output node 11, that can itself be powered by an external power supply or other power supply that is different than the first power supply.

On an integrated circuit, the first power supply can comprise a charge pump 15 generating the voltage Vpump to the first power supply circuit 20, which distributes the voltage as necessary to circuitry on the integrated circuit in which the LDO circuit 10 is implemented.

Also, the integrated circuit can include the second power supply circuit 21 which is configured for connection to an external power supply, such as by including an input/output pad, or other connection structure on the device. The integrated circuit can include a third power supply circuit 22 which is configured for connection to a different power supply, or to one of the first and second power supplies as suits a particular embodiment.

Also, the output leg of the voltage regulator can be connected to a fourth power supply circuit 23. In the illustrated embodiment, the fourth power supply circuit 23, third power supply circuit 22 and the second power supply circuit 21 can be combined into a single circuit for distribution of the external supply voltage VDD_EXT. In other embodiments, different combinations of power supplies can be connected to the power supply circuits 21, 22, 23.

In one example, the system circuits 12 comprise an integrated circuit memory. The system circuits 12 can comprise a variety of circuits other than integrated circuit memory. In the integrated circuit memory example, the system circuits 12 include a memory array and peripheral circuits used during operation of the memory array. The peripheral circuits can include a state machine or other logic circuitry used to change the operating modes of the memory. For example, the memory can include a page read mode with error correction. A transition in current loading driven by the voltage regulator can change rapidly during various stages of a page read operation. For example, during a page read operation with error correction, there can be a rapid increase in current loading when error correction operations are initiated as the data is retrieved from the memory array. By way of example, the increase in current loading can occur on a nanosecond scale as the error correction circuits are engaged to process a page of data retrieved from the memory. A corresponding decrease in current loading can occur when the error correction operation completes.

A method for supplying a regulated voltage to a target circuit can be carried out using a circuit like that of FIG. 1. The method includes applying the regulated voltage on an output node 11 coupled to the target system circuit 12. The regulated voltage is supplied using a first amplifier stage (LDO circuit 10) and a second amplifier stage (slew rate boost circuit 14). The method includes supplying power to the first amplifier stage using a first power supply, such as a charge pump, and supplying power to the second amplifier stage using a second power supply. The second power supply can have a higher driving power than the first power supply. During a transition in current loading on the output node, the method includes turning off the second amplifier stage before the first amplifier stage. In this manner, the output voltage of the regulator can be driven by the combination of the first and second amplifier stages during a transition in current loading on the output node for a faster slew rate, and can be driven by the first amplifier stage based on the first power supply during a second part of the transition.

The voltage regulator output leg can include a transistor having a gate, a first terminal connected to a power supply circuit, such as the circuit that distributes VDD_EXT from an external power supply, and a second terminal connected to the output node. The power supply voltage (e.g. VDD_EXT) received at the first terminal of the transistor can be lower than the power supply voltage (e.g. Vpump) provided by the first power supply. Thus, the regulated voltage on the output can be very close to, and in some embodiments higher than, the power supply voltage (in this example, VDD_EXT) on the first terminal of the transistor.

For example, an external supply voltage VDD_EXT can be between about 1.6 and about 2.2 V. A charge pump can be provided that provides a power supply voltage Vpump that is about 2 V. Thus, the power supply voltage Vpump provided by the charge pump can be close to, and even greater than, the voltage VDD_EXT provided by the external supply. This improves the ability of the voltage regulator to provide an output voltage closer to 2 V, even given variations in the external supply voltage.

FIG. 2 is a circuit diagram of an embodiment of a voltage regulator with fast slew rate according to the technology described herein. The circuit in FIG. 2 includes a first operational amplifier 80 connected to, such as by having at least an output driving circuit powered by, a first power supply circuit 100 that distributes a voltage Vpump from a charge pump, and a second operational amplifier 90 connected to, such as by having at least an output driving circuit connected to, a power supply node that can be part of second power supply circuit 101 that distributes a voltage VDD_EXT from an external power supply in this example. The output of the first operational amplifier 80 is connected to the node 84 at which the voltage VG is generated. The output (V2) of the second operational amplifier 90 is also connected to the node 84 via a diode. In this example, the diode is implemented using a diode-connected MOS transistor 93 connected in series between the output of the second operational amplifier and the node 84. The diode serves to isolate the node 84 from the output of the second operational amplifier as the voltage VG on node 84 approaches V2.

The voltage regulator includes a transistor 81, which is an n-channel power MOSFET in this example, having a drain coupled to the second power supply circuit 101 that distributes a voltage VDD_EXT from the external power supply, and having a source coupled to the output node 86. In other embodiments, the drain can be coupled to a different power supply circuit. The output node 86 supplies the power supply voltage VDD_INT, and is connected to a target circuit, which can include system circuits 87 for an integrated circuit which are powered by VDD_INT.

A feedback circuit is coupled between the output node and the “−” inputs (feedback inputs in this example) of both the first operational amplifier 80 and the second operational amplifier 90. A voltage reference supplies first bias reference voltage VREF1 (e.g. about 1 V) on line 79 to the “+” input of the first operational amplifier. A voltage reference supplies second bias reference voltage VREF2 (e.g. about 0.96 V) which can be slightly lower than the voltage VREF1, on line 91 to the “+” input of the second operational amplifier 90. The voltage references supplying the bias reference voltages VREF1 and VREF2 can be based on a shared bandgap reference circuit, or based on different bandgap reference circuits in some embodiments.

The diode-connected transistor 93 can comprise a low threshold voltage (low-Vt) MOS transistor, which for the purposes of this description is a transistor which has a modification that reduces its threshold voltage as compared to other transistors used for logic circuitry on the integrated circuit. In some embodiments, the threshold voltage of the low-Vt voltage MOS transistor can be about 0.1 or 0.2 V. For example, the threshold voltage can be reduced relative to other transistors on the integrated circuit by varying channel doping and/or gate dielectric thickness.

The feedback circuit in this example includes resistors 82 and 83 in series between the output node 86 and ground, and connector 85 connecting a node between resistors 82 and 83, at which a feedback voltage VFB is generated, to the “−” input of the first operational amplifier 80 and to the “−” input of the second operational amplifier 90.

The resistors 82, 83 have values R1 and R2 which can be set to determine the level of the internal supply voltage VDD INT generated on the output node 86.

In this configuration, the first operational amplifier 80 receives its power supply voltage from a charge pump, which may provide relatively low driving current while providing higher possible output voltages. The second operational amplifier 90 receives its power supply voltage from an external supply, which may provide relatively high driving current but lower possible output voltages. Because VREF2 is lower than VREF1, the second operational amplifier 90 will turn off earlier (i.e. at a lower feedback voltage VFB) than the first operational amplifier 80. Thus, the DC level of voltage VG on node 84, and the corresponding regulated voltage VDD_INT on the output node 86 in this example is determined finally by the first operational amplifier 80, and the output of the second operational amplifier 90 while not affecting the final level of the voltage VG on node 84, provides driving power to boost the slew rate of the regulator during transitions in current loading by the system circuits 87.

The second operational amplifier 90 can be configured to turn off before the first operational amplifier 80 using circuit configurations other than that shown in FIG. 2, during transitions in current loading in the system circuits 87.

The embodiment of FIG. 2 uses an LDO with an n-channel power transistor 81. In alternative embodiments, an LDO with a p-channel power transistor can be used.

Technology is described for producing a regulated voltage for circuits having fast changes in current loading that includes circuits to boost the response time of the regulator, so that the regulated voltage will stabilize quickly with a fast slew rate. According to simulations, the set up time for a voltage regulator configured as described herein can be improved relative to a typical LDO voltage regulator by 15% to 45%.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims. What is claimed is:

1. A device, comprising:
a voltage regulator to supply a regulated voltage on an output node, the voltage regulator including an amplifier, an output leg including a control input connected to an output of the amplifier, and the output node, and a feedback circuit between the output node and an input of the amplifier and providing a feedback signal in response to variations in voltage on the output node;
the amplifier including a first stage connected to a first power supply circuit configured to be connected to a first power supply, and a second stage connected to a second power supply circuit configured to connect to a second power supply, the second power supply circuit different than the first power supply circuit, the first stage connected to the feedback circuit, and having a first stage output connected to the output of the amplifier, and the second stage connected to the feedback circuit, and having a second stage output connected to the output of the amplifier so that the output of the amplifier causes variation of the control voltage in response to both the first stage output and the second stage output, the second stage turning off before the first stage during transitions in current loading on the output node.

2. The device of claim 1, including a charge pump circuit connected as the first power supply to the first power supply circuit.

3. The device of claim 2 wherein the second power supply circuit includes a conductor configured to be connected to an external power supply.

4. The device of claim 1, wherein the output leg is connected to a power supply circuit that distributes a different power supply voltage than the first power supply circuit.

5. A device, comprising:
a voltage regulator to supply a regulated voltage on an output node, the voltage regulator including an amplifier, an output leg including the output node, and a feedback circuit between the output node and an input of the amplifier;
the amplifier including a first stage connected to a first power supply circuit configured to be connected to a first power supply, and a second stage connected to a second power supply circuit configured to connect to a second power supply, the second power supply circuit different than the first power supply circuit;
wherein the first stage comprises a first operational amplifier connected to the first power supply circuit, and an output connected to the output leg; and
the second stage comprises a second operational amplifier connected to the second power supply circuit, and an output, and a diode connected in series between the output of the second operational amplifier and the output leg.

6. The device of claim 5, including a first bias reference voltage supplied to an input of the first operational amplifier, and a second bias reference voltage supplied to an input of the second operational amplifier, the second bias reference voltage having a lower magnitude than the first bias reference voltage.

7. The device of claim 5, wherein the diode comprises a diode-connected low-Vt transistor.

8. The device of claim 1, wherein the output leg includes a transistor having a gate connected to the output of the amplifier, a first terminal connected to a third power supply circuit, and a second terminal connected to the output node.

9. A device, comprising:
a first operational amplifier having a reference input, a feedback input and an output;
a second operational amplifier having a reference input, a feedback input and an output;
a transistor having a gate connected to the output of the first operational amplifier, a first terminal, and a second terminal connected to an output node;
a diode between the output of the second operational amplifier and the gate of the transistor;
a feedback circuit between the output node and feedback inputs of the first and second operational amplifiers;
a first power supply circuit connected to the first operational amplifier, and configured to be connected to a first power supply; and
a second power supply circuit connected to the second operational amplifier, and configured to be connected to a second power supply.

10. The device of claim 9, wherein the second power supply circuit is connected to the first terminal of the transistor.

11. The device of claim 9, wherein the diode comprises low-Vt diode-connected transistor.

12. The device of claim 9, including a charge pump circuit connected to the first power supply circuit as the first power supply.

13. The device of claim 12, wherein the second power supply circuit includes a conductor configured to be connected to an external power supply.

14. The device of claim 9, including a first bias reference voltage supplied to the reference input of the first operational amplifier, and a second bias reference voltage supplied to the reference input of the second operational amplifier, the second bias reference voltage having a lower magnitude than the first bias reference voltage.

15. A method for supplying a regulated voltage to a target circuit, comprising:
supplying the regulated voltage on an output node coupled to the target circuit using a transistor having a gate, a first terminal, and a second terminal connected to the output node; and
driving the gate of the transistor using a first amplifier stage and a second amplifier stage;
supplying power to the first amplifier stage using a first power supply;
supplying power to the second amplifier stage using a second power supply having higher power than the first power supply; and
during a transition in current loading on the output node, turning off the second amplifier stage before the first amplifier stage.

16. The method of claim 15, including:
applying different bias reference voltages to reference inputs of the first and second amplifier stages, and a feedback voltage to feedback inputs of the first and second amplifier stages; and
turning off the second amplifier stage before the first amplifier stage by using a lower bias reference voltage on the second amplifier stage.

17. The method of claim 15, wherein the first power supply comprises a charge pump which produces a power supply voltage higher than a power supply voltage produced by the second power supply.

18. The method of claim 15, including applying a power supply voltage to the first terminal of the transistor that has a lower magnitude than a voltage applied by the first power supply to the first amplifier stage.

19. The method of claim 15, including using a diode to block current flow between the gate of the transistor to the second amplifier stage when a voltage on the gate is near a voltage generated by the second amplifier stage.
